(19) United States
(12) Patent Application Publication
(10) Pub. No.: US 2026/0156063 A1
(43) Pub. Date: Jun. 4, 2026

(54) Heartbeat Diagnostic for Fast Detection of Communications Loss

(71) Applicant: ROCKWELL AUTOMATION TECHNOLOGIES, INC., MAYFIELD HEIGHTS, OH (US)

(72) Inventors: Ashvin K. Kudva, Mayfield Heights, OH (US); Nicholas L. Stay, Milwaukee, WI (US)

(21) Appl. No.: 18/965,078

(22) Filed: Dec. 2, 2024

(51) Int. Cl. H04L 43/10; H04L 1/1867

(52) U.S. Cl. CPC H04L 43/10; H04L 1/188

(57) ABSTRACT

Systems, methods, devices, and media for detecting communications faults in a control system. An example method includes using faster heartbeat messages during active communication periods between a first device and a second device to provide faster detection of communications faults. Then, during inactive communication periods, the method includes using slower (baseline level) heartbeat messages such that the first device and the second device conserve computing resources. As a result, high levels of safety integrity can be provided within a control system 100 without excessively using computing resources.

### BACKGROUND INFORMATION

The present disclosure relates generally to electronic communication between devices in a control system. Systems, devices, methods, and media that can provide improvements in various types of control systems are generally desired.

### BRIEF DESCRIPTION

One aspect of the disclosure is a method for detecting a communications fault in a control system. The method includes sending, by a first device in the control system during a first time period, a first message to a second device in the control system, the first message comprising data associated with the control system and a first heartbeat timeout period; receiving, by the second device during the first time period, the first message from the first device; sending, by the second device during the first time period, heartbeat messages to the first device in accordance with the first heartbeat timeout period; receiving, by the first device during the first time period, the heartbeat messages from the second device in accordance with the first heartbeat timeout period; detecting, by the first device during the first time period, the communications fault in the control system responsive to detecting that the heartbeat messages are no longer being received from the second device in accordance with the first heartbeat timeout period; and sending, by the first device, a second message to the second device during a second period, the second message comprising a second heartbeat timeout period that is longer than the first heartbeat timeout period.

Another aspect of the disclosure is one or more non-transitory computer-readable storage media having instructions stored thereon that, when executed by processing circuitry, cause the processing circuitry to send, from a first device in a control system during a first time period, a first message to a second device in the control system, the first message comprising data associated with the control system and a first heartbeat timeout period; receive, at the second device during the first time period, the first message from the first device; send, from the second device during the first time period, heartbeat messages to the first device in accordance with the first heartbeat timeout period; receive, at the first device during the first time period, the heartbeat messages from the second device in accordance with the first heartbeat timeout period; detect, at the first device during the first time period, a communications fault in the control system responsive to detecting that the heartbeat messages are no longer being received from the second device in accordance with the first heartbeat timeout period; and send, from the first device, a second message to the second device during a second period, the second message comprising a second heartbeat timeout period that is longer than the first heartbeat timeout period.

Yet another aspect of the disclosure is a device in a control system. The device includes memory to store instructions and processing circuitry to execute the instructions to send, during a first time period, a first message to a second device in the control system, the first message comprising data associated with the control system and a first heartbeat timeout period; receive, during the first time period, first heartbeat messages from the second device in accordance with the first heartbeat timeout period; detect, by the first device during the first time period, a first communications fault responsive to detecting that the heartbeat messages are no longer being received from the second device in accordance with the first heartbeat timeout period; send, during a second time period, a second message to the second device, the second message comprising a second heartbeat timeout period that is longer than the first heartbeat timeout period; receive, during the second time period, the second heartbeat messages from the second device in accordance with the second heartbeat timeout period; and detect, during the second time period, a second communications fault responsive to detecting that the second heartbeat messages are no longer being received from the second device in accordance with the second heartbeat timeout period.

### BRIEF DESCRIPTION OF THE DRAWINGS

FIG. 1 is a block diagram illustrating an example control system, in accordance with some aspects of the disclosure.

FIG. 2 is an example diagram illustrating an example of communications between two devices in the control system of FIG. 1, in accordance with some aspects of the disclosure.

FIG. 3 is a flow diagram illustrating an example process for detecting a communications fault in the control system of FIG. 1, in accordance with some aspects of the disclosure.

### DETAILED DESCRIPTION

In communication systems, losses can occur as a result of communication faults between two or more devices. For example, two devices can communicate with one another in an industrial control system to send and receive various types of data. An interruption can occur when a first device loses connection with a second device. One particular challenge in communication systems lies in the detection of such interruptions. In industrial control systems, some devices (e.g., edge devices) may have low computational capabilities, which prevent them from implementing fast detection loss procedures. The communications techniques detailed herein can generally be used to provide faster detection of communications losses in industrial control systems (or other types of systems). For example, the techniques described herein can be used to efficiently detect losses in communication between various devices such as relays, motor starters, circuit breakers, variable frequency drives, and programmable logic controllers (PLCs) that can provide functionality for controlling a system and/or process.

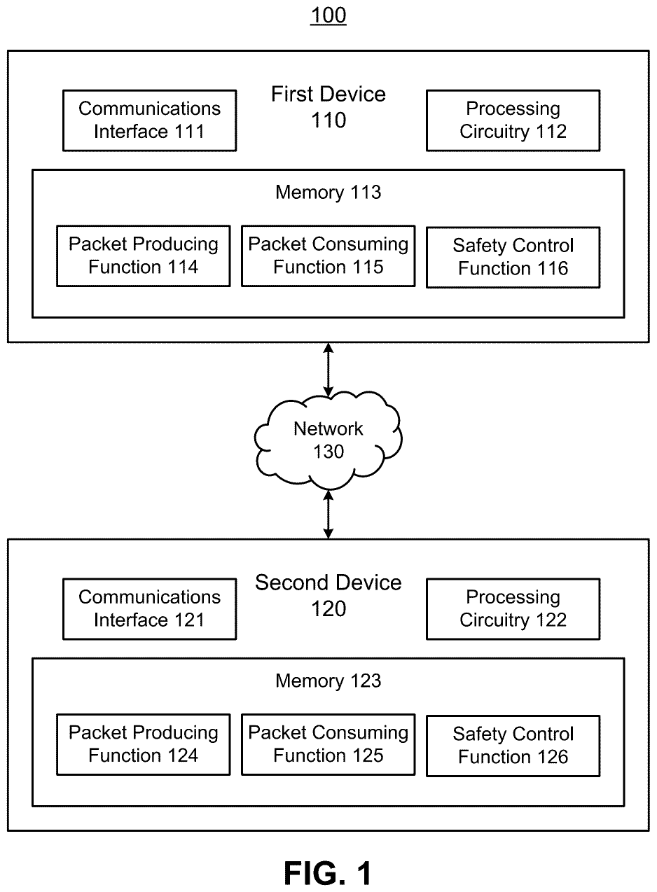

Referring to FIG. 1, a block diagram illustrating an example control system 100 is shown, in accordance with some aspects of the disclosure. As shown, the control system 100 can include a first device 110, a second device 120, and a network 130. The control system 100 can be used to automate various types of industrial processes. For example, the control system 100 can be used to automate manufacturing processes in industries such as aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others.

The first device 110 and the second device 120 can be configured to communicate with each over the network 130 in a manner that both provides faster detection of communications losses and does not overload the computing resources of the first device 110 and the second device 120. The first device 110 and the second device 120 can be implemented as safety PLCs within the control system 100. For example, both the first device 110 and the second device 120 can be implemented as ControlLogix® 5580 controllers from Rockwell Automation, Inc., among other possible types of safety PLCs. Additionally, one or both of the first device 110 and the second device 120 can be implemented as edge computing devices with limited computing resources (e.g., sensor devices or other types of edge devices), among other possibilities.

As shown in FIG. 1, the first device 110 can include a communications interface 111, processing circuitry 112, and memory 113. The memory 113 can then include a packet producing function 114, a packet consuming function 115, and a safety control function 116. The communications interface 111 can include any suitable circuitry and/or interfaces for connecting the first device 110 to the network 130 and/or to one or more power sources. For example, the communications interface 111 can include various suitable types of communications ports, such as Ethernet communications ports, serial communications ports, power interfaces, and/or other suitable types of interfaces. The processing circuitry 112 can similarly include any suitable types of processing circuitry (e.g., one or more central processing units (CPUs), one or more graphics processing units (GPUs), one or more application specific integrated circuits (ASICs), one or more field-programmable gate arrays (FPGAs), etc.) with any suitable configuration of processing cores. The memory 113 can also include any suitable types of memory (e.g., volatile, non-volatile, random-access memory (RAM), read-only memory (ROM), electrically erasable programmable read-only memory (EEPROM), etc.). The memory 113 can include one or more non-transitory machine-readable storage media having instructions stored thereon that, when executed by the processing circuitry 112, cause the processing circuitry to perform operations in accordance with the instructions.

The packet producing function 114 can include instructions that, when executed by the processing circuitry 112, cause the first device 110 to produce and export data packets. The data packets can include segments of data to be sent over the network 130 to the second device 120 and/or to other devices in the control system 100. For example, the data packets can include sensor data, network data, control data, equipment data, and/or any other types of data associated with the control system 100. The packet producing function 114 can also produce heartbeat messages while actively communicating with the second device 120 (and/or other devices in the control system 100). The heartbeat messages can generally be used to indicate to the first device 110 is “listening” for communications from the second device 120, such that the second device 120 can know that the connection with the first device 110 over the network 130 is in place and that no loss or other type of communication fault has occurred.

The packet producing function 114 can produce these heartbeat messages dynamically depending on whether or not the second device 120 is actively communicating with the first device 110. For example, when the first device 110 wants to communicate actively with the second device 120, the packet producing function 114 can produce heartbeat messages in accordance with a first heartbeat timeout period (e.g., 1 millisecond). However, when the first device 110 does not need to communicate actively with the second device 120, the packet producing function 114 can produce heartbeat messages in accordance with a second heartbeat timeout period (e.g., 10 milliseconds) that is longer than the first heartbeat timeout period. When compared to other approaches (e.g., using a static heartbeat timeout period that does not change), this dynamic packet producing functionality provided by the packed producing function 114 can both allow the second device 120 to detect a loss in communication with the first device 110 faster than otherwise possible and save computing resources for the first device 110 during time periods where the first device 110 and the second device 120 are not actively communicating.

The packet consuming function 115 can include instructions that, when executed by the processing circuitry 112, cause the first device 110 to consume data packets received from the second device 120 and/or from other devices in the control system 100. For example, the packet consuming function 115 can receive data packets including sensor data, network data, control data, equipment data, and/or any other types of data associated with the control system 100. The packet consuming function 115 can also receive heartbeat messages sent by the second device 120 to the first device 110, and can use the heartbeat messages to determine whether a communications fault has occurred in the control system 100. The heartbeat messages received from the second device 120 can include a heartbeat timeout period that can be used by the packet consuming function 115 to detect a communications fault. For example, the packet consuming function 115 can receive a first heartbeat message from the second device 120 indicating a heartbeat timeout period of 1 millisecond. Then, if the packet consuming function 115 does not receive a second heartbeat message from the second device 120 within the period of 1 millisecond, the packet consuming function 115 can determine detect that a communications fault has occurred.

The safety function 116 can include instructions that, when executed by the processing circuitry 112, cause the first device 110 to perform safety functionality for the control system 100. For example, the safety function 116 can include instructions that are executable by the processing circuitry 112 to cause the first device 110 to perform one or more diagnostic functions to analyze data received via the communications interface 111 to detect safety faults that may occur within the control system 100. The safety function 116 can thereby allow the first device 110 to comply with various requirements and standards pertaining to safety and reliability of the control system 100. In response to detecting one or more safety faults, the safety function 116 can cause the first device 110 to perform various types of remedial actions. For example, in response to detecting one or more safety faults, the safety function 116 can cause the first device 110 to shut down equipment in the control system 100 (e.g., shut down a conveyer, lock a gate, etc.) or otherwise control equipment in the control system 100 by affecting the operation of the equipment in the control system 100.

As shown in FIG. 1, the second device 120 can similarly include a communications interface 121, processing circuitry 122, and memory 123. The memory 123 can then include a packet producing function 124, a packet consuming function 125, and a safety control function 126. The communications interface 121 can again include any suitable circuitry and/or interfaces for connecting the second device 120 to the network 130 and/or to one or more power sources. For example, the communications interface 121 can include various suitable types of communications ports, such as Ethernet communications ports, serial communications ports, power interfaces, and/or other suitable types of interfaces. The processing circuitry 122 can similarly include any suitable types of processing circuitry (e.g., one or more CPUs, one or more GPUs, one or more ASICs, one or more FPGAs, etc.) with any suitable configuration of processing cores. The memory 123 can also include any suitable types of memory (e.g., volatile, non-volatile, RAM, ROM, EEPROM, etc.). The memory 123 can again include one or more non-transitory machine-readable storage media having instructions stored thereon that, when executed by the processing circuitry 112, cause the processing circuitry to perform various operations in accordance with the instructions.

The packet producing function 124 can include instructions that, when executed by the processing circuitry 122, cause the second device 120 to produce and export data packets. The data packets can include segments of data to be sent over the network 130 to the first device 110 and/or to other devices in the control system 100. For example, the data packets can include sensor data, network data, control data, equipment data, and/or any other types of data associated with the control system 100. The packet producing function 124 can also produce heartbeat messages while actively communicating with the first device 110 (and/or other devices in the control system 100). The heartbeat messages can again generally be used to indicate to the second device 120 is “listening” for communications from the first device 110, such that the first device 110 can know that the connection with the second device 120 over the network 130 is in place and that no loss or other type of communication fault has occurred.

The packet producing function 124 can again produce heartbeat messages dynamically depending on whether or not the first device 110 is actively communicating with the second device 120. For example, when the second device 120 wants to communicate actively with the first device 110, the packet producing function 124 can produce heartbeat second device 120 does not need to communicate actively with the first device 110, the packet producing function 124 can produce heartbeat messages in accordance with a second heartbeat timeout period that is longer than the first heartbeat timeout period (e.g., 10 milliseconds). When compared to other approaches (e.g., using a static heartbeat timeout period that does not change), this dynamic packet producing functionality provided by the packed producing function 124 can both allow the first device 110 to detect a loss in communication with the second device 120 faster than otherwise possible and save computing resources for the second device 120 during time periods where the second device 120 and the first device 110 are not actively communicating.

The packet consuming function 125 can include instructions that, when executed by the processing circuitry 122, cause the second device 120 to consume data packets received from the first device 110 and/or from other devices in the control system 100. For example, the packet consuming function 125 can receive data packets including sensor data, network data, control data, equipment data, and/or any other types of data associated with the control system 100. The packet consuming function 125 can also receive heartbeat messages sent by the first device 110 to the second device 120, and can use the heartbeat messages to determine whether a communications fault has occurred in the control system 100. The heartbeat messages received from the first device 110 can include a heartbeat timeout period that can be used by the packet consuming function 125 to detect a communications fault. For example, the packet consuming function 125 can receive a first heartbeat message from the first device 110 that indicates a heartbeat timeout period of 1 millisecond. Then, if the packet consuming function 125 does not receive a second heartbeat message from the first device 110 within the period of 1 millisecond, the packet consuming function 125 can determine detect that a communications fault has occurred.

The safety function 126 can include instructions that, when executed by the processing circuitry 122, cause the second device 120 to perform safety functionality for the control system 100. For example, the safety function 126 can include instructions that are executable by the processing circuitry 122 to cause the second device 120 to perform one or more diagnostic functions to analyze data received via the communications interface 121 to detect safety faults that may occur within the control system 100. The safety function 126 can thereby allow second device 120 to comply with various requirements and standards pertaining to safety and reliability of the control system 100. In response to detecting one or more safety faults, the safety function 126 can cause the second device 120 to perform various remedial actions. For example, in response to detecting one or more safety faults, the safety function 126 can cause the second device 120 to shut down equipment in the control system 100 (e.g., shut down a conveyer, lock a gate, etc.) or otherwise control equipment in the control system 100 by affecting the operation of the equipment in the control system 100. In some examples, the processing circuitry 112 of the first device 110 can execute the safety function 116 and the processing circuitry 122 of the second device 120 can execute the safety function 126 in a manner such that the first device 110 and the second device 120 can perform coordinated (cooperative) safety control functionality within the control system 100.

The network 130 can be implemented in various suitable manners, including using one or multiple separate wired and/or wireless communications networks. For example, the network 130 can be implemented using a wired connection (e.g., an Ethernet connection, etc.) between the first device 110 and the second device 120. The network 130 can also be implemented using one or more intermediary networking devices (e.g., network switching devices, etc.) and/or other types of devices that are connected between the first device 110 and the second device 120. These intermediary devices can be installed in one or more electrical panels in a manufacturing facility, for example, that are different from or the same as an electrical panel in which one or both of the first device 110 and/or the second device 120 are installed in. The network 130 can use one or more different types of communications protocols to communicatively couple the first device 110 to the second device 120. For example, the network 130 can use protocols such as Common Industrial Protocol (CIP), Ethernet, Ethernet/IP, DeviceNet, CompoNet, ControlNet, Wi-Fi, serial (e.g., universal serial bus (USB), etc.), Bluetooth, cellular (e.g., 3G, 4G, 5G, etc.), and/or other suitable types of communications protocols to communicatively couple the first device 110 to the second device 120, and/or to communicatively couple other devices within the control system 100.

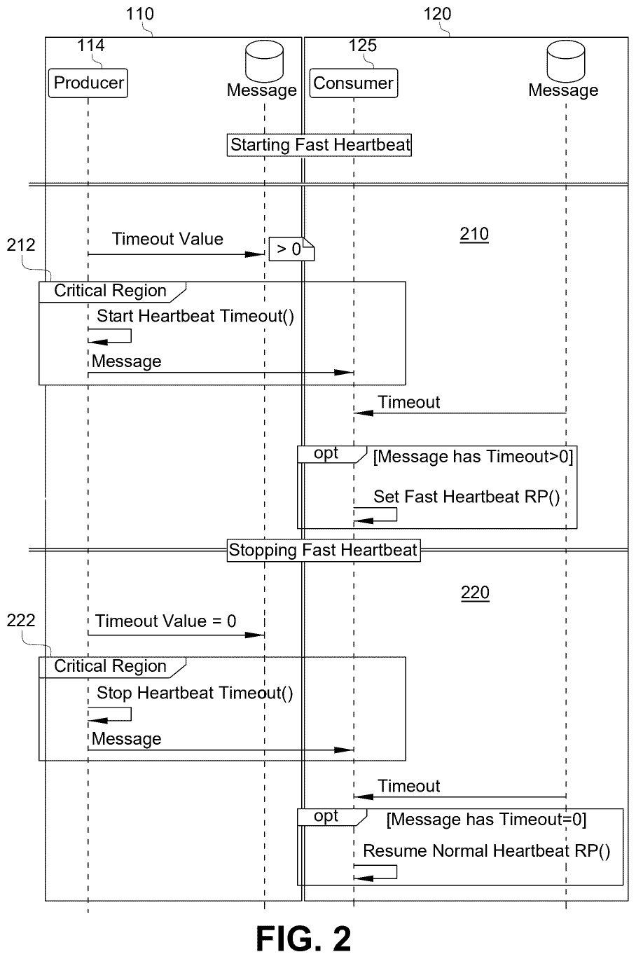

Referring to FIG. 2, an example diagram illustrating communications between the first device 110 and the second device 120 during two different time periods is shown, in in accordance with some aspects of the disclosure. As shown, during a first time period 210, the first device 110 can communicate with the second device 120 to start a fast heartbeat sequence. In some examples, the fast heartbeat sequence can be used during active communication between the first device 110 and the second device 120. During the first time period 210, the processing circuitry 112 of the first device 110 can execute the packet producing function 114 stored in the memory 113 of the first device 110 to initiate the fast heartbeat sequence by generating and sending a first message 212 to the second device 120. The first message 212 can include data associated with the control system 100 and a first heartbeat timeout period with a value that is greater than zero. The first heartbeat timeout period with the value greater than zero can be included in a header of the first message 212 to provide ease of detection by the second device 120.

The first heartbeat timeout period with the value greater than zero can indicate to the second device 120 that the speed of heartbeat communications between the first device 110 and the second device 120 should be increased (e.g., above a normal or baseline level of zero). Also, during the first time period 210, the second device 120 can send fast heartbeat signals to the first device 110 in accordance with the first heartbeat timeout period specified by the first message 212. The processing circuitry 122 of the second device 120 can execute the packet consuming function 125 stored in the memory 123 of the second device 120 can process the first message 212 received from the first device 110 to determine the first heartbeat timeout period.

Then, as shown, during a second time period 220, the first device 110 can communicate with the second device 120 to stop the fast heartbeat sequence. In some examples, the first device 110 can stop the fast heartbeat signals responsive to determining that actively communicating with the second device 120 is no longer necessary (e.g., when the first device 110 does not have data associated with the control system 100 that it needs to send to the second device 120). During the second time period 220, the processing circuitry 112 of the first device 110 can execute the packet producing function 114 stored in the memory 113 of the first device 110 to stop the fast heartbeat sequence by generating and sending a second message 222 to the second device 120. The second message 222 can include a second heartbeat timeout period with a value that is equal to zero, for example. The second heartbeat timeout period with the value hat is equal to zero can be included in a header of the second message 222 to provide ease of detection by the second device 120.

The second heartbeat timeout period with the value equal to zero can indicate to the second device 120 that the speed of heartbeat communications between the first device 110 and the second device 120 should be decreased (e.g., back to a normal or baseline level of zero). Accordingly, the second heartbeat timeout period can be a longer time period when compared to the first heartbeat timeout period. Then, during the second time period 220, the second device 120 can send slower (baseline) heartbeat signals to the first device 110 in accordance with the second heartbeat timeout period specified by the second message 222. The processing circuitry 122 of the second device 120 can execute the packet consuming function 125 stored in the memory 123 of the second device 120 can process the second message 222 received from the first device 110 to determine the second heartbeat timeout period. The first time period 210 and the second time period 220 can be any suitable length time periods that can vary depending on the nature of the communications between the first device 210 and the second device 220. Additionally, the first time period 210 can occur before or after the second time period 220.

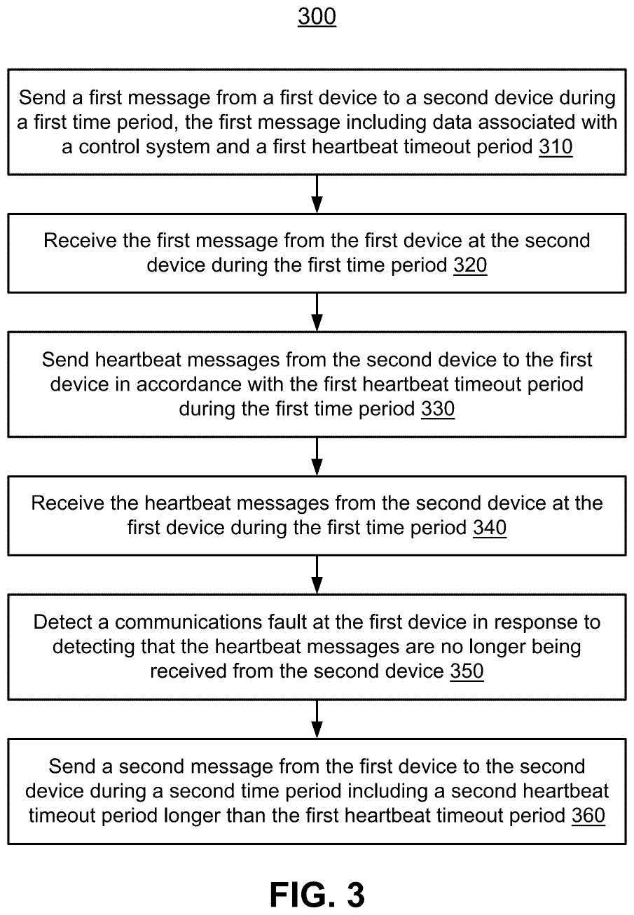

Referring to FIG. 3, a flow diagram illustrating an example process 300 for detecting a communications fault in the control system 100 is shown, in accordance with some aspects of the disclosure. The process 300 can be performed by the first device 110 and the second device 120, for example. The process 300 can be implemented within the control system 100 to provide advantages in terms of faster detection of communications faults and conservation of computing resources for the first device 110 and the second device 120. In particular, the process 300 can use faster heartbeat messages during periods of active communication between the first device 110 and the second device 120 to provide faster detection of communications faults. Then, during periods where the first device 110 and the second device 120 do not actively communicate, the process 300 can use slower (baseline) heartbeat messages such that the first device 110 and the second device 120 can conserve computing resources during such periods. As a result, the process 300 can be used to provide high levels of safety integrity within the control system 100 (e.g., SIL 3, etc.) without excessively using computing resources available on the first device 110 and the second device 120.

The process 300 can generally be used to handle communications faults in a dual channel safety system (e.g., Logix SIS as from Rockwell Automation, Inc.). When two channels in such a system stop communicating (e.g., channels between the first device 110 and the second device 120), the stoppage needs to be detected within a given reaction time to prevent shutting down of the safety functionality (e.g., execution of the safety function 116 and/or the safety function 126). The process 300 can be used in a distributed or high availability system (e.g., the control system 100) where two or more control functions are cooperating (e.g., the safety function 116 and/or the safety function 126) to allow one of the control functions to operate in isolation (as opposed to shutting both down entirely) responsive to detecting a communications fault. The process 300 can be especially beneficial when implemented in constrained networks (e.g., with limited bandwidth, etc.) and/or with devices with limited computing resources (e.g., edge devices). In some examples, the process 300 can act as a watchdog for a safety task (e.g., the safety control function 116, the safety control function 126, etc.) that can be executed by the processing circuitry 112 and/or the processing circuitry 122.

At 310, the process 300 can include sending a first message from a first device to a second device, where the first message includes data associated with a control system and a first heartbeat timeout period. For example, the first device 110 can send, during the first time period 210, the first message 212 to the second device 120 via the communications interface 111, and the first message 212 can include data associated with the control system 100 and the first heartbeat timeout period. The first device 110 can generally use the first message 212 to start a fast heartbeat (e.g., in anticipation of active communication between the first device 110 and the second device 120). The data associated with the control system 100 can include any suitable data such as sensor data, network data, control data, equipment data, and/or any other types of data associated with the control system 100. The first device 110 can generate the first message 212 such that the first message 212 includes a header that contains the first heartbeat timeout period. The first message 212 can be any of a variety of suitable types of messages depending on the application.

The first device 110 can send the first message 212 to the second device 120 at 310 directly or indirectly. For example, at 310, the first device 110 can send the first message 212 to the second device 120 directly via a wired communications link (e.g., via an Ethernet connection etc.) or a wireless communications link. The first device 110 can also send the first message 212 to the second device 120 through one or more intermediary devices (e.g., one or more network switches and/or other devices via the network 130). Advantageously, the first device 110 can receive the first heartbeat timeout period based on a user input such that the first heartbeat timeout period is user configurable. For example, a user associated with the control system 100 can make the first timeout period shorter or longer as appropriate for a specific application. The user can provide the user input via various suitable user devices and various suitable types of user interfaces associated with the control system 100. In some examples, to provide advantageous functionality for meeting various safety standards, the first timeout period can be between 0.5 milliseconds and 3 milliseconds. Additionally, in some examples, the first heartbeat timeout period can be defined (by a user or otherwise) based on frequencies of other processes running on the first device 110 and/or the second device 120. For example, the first device 110 and/or the second device 120 can include a safety scan time associated with the safety function 116 and/or the safety function 126 and, to avoid a fault that may shut down the safety scan, the first heartbeat timeout period can be set to a frequency that is greater than the frequency of the safety scan. The first heartbeat timeout period can define a requested packet interval (RPI), for example.

At 320, the process 300 can include receiving, at the second device, the first message from the first device during the first time period. For example, the second device 120 can receive the first message 212 that is sent from the first device 110 during the first time period 210 via the communications interface 121. At 330, the process 300 can include sending heartbeat messages from the second device to the first device in accordance with the first heartbeat timeout period. For example, the second device 120 can send one or more heartbeat messages to the first device 110 during the first time period 210 via the communications interface 121. The second device 120 can send the heartbeat messages to the first device 110 at 330 directly or indirectly. For example, at 330, the second device 120 can send the heartbeat messages to the first device 110 via a wired communications link or a wireless communications link, and/or through one or more intermediary devices. The second device 120 can send any suitable number of heartbeat messages to the first device 110 at 330 depending on the length of the first time period 210 and the length of the first heartbeat timeout period. For example, if the first heartbeat timeout period is 1 millisecond, then the second device 120 can send individual heartbeat messages to the first device 110 every 1 millisecond until the second device 120 receives the second message 222 from the first device 110 to stop the fast heartbeat. The second device 120 can generate the heartbeat messages by executing the packet producing function 124 to generate data packets containing the heartbeat messages for transmission to the first device 110 at 330 in accordance with the production rate defined by the first heartbeat timeout period, for example.

At 340, the process 300 can include receiving, at the first device, the heartbeat messages from the second device during the first time period. For example, the first device 110 can receive the heartbeat messages from the second device 120 during the first time period 210 via the communications interface 111. At 350, the process 300 can include detecting a communications fault at the first device responsive to detecting that the heartbeat messages are no longer being received form the second device during the first time period in accordance with the first heartbeat timeout period. For example, at 350, the first device 110 can detect that the communications fault has occurred responsive to detecting that a time period greater than the first heartbeat timeout period has elapsed since the last heartbeat message was received from the second device 120 via the communications interface 111. The communications fault can be indicative of a complete or partial loss (e.g., an interruption, etc.) of communications.

In the example where the first heartbeat timeout period is 1 millisecond, the first device 110 can detect that the communications fault has occurred responsive to detecting that a period of 1.1 milliseconds has elapsed since the last heartbeat message was received from the second device 120 via the communications interface 111. The first device 110 can use any suitable buffer time period to make the fault detection. Again, in the example where the first heartbeat timeout period is 1 millisecond, the first device 110 could also detect that the communications fault has occurred responsive to detecting that a period of 1.2 milliseconds has elapsed (e.g., using a 0.2 millisecond buffer period instead of a 0.1 millisecond buffer period) since the last heartbeat message was received from the second device 120 via the communications interface 111. Responsive to detecting the communications fault at 350, the first device 110 can perform various types of remedial actions. For example, the first device 110 can shut down equipment in the control system 100 (e.g., shut down a conveyer, lock a gate, turn off a motor, etc.) or otherwise control equipment in the control system 100 by affecting the operation of the equipment in the control system 100. The first device 110 can also execute the safety function 116 in isolation responsive to detecting the communications fault at 350, as opposed to executing the safety function 116 in cooperation with the second device 120 (e.g., in cooperation with the safety function 126).

At 360, the process 300 can include sending a second message from the first device to the second device during a second time period, where the second message includes a second heartbeat timeout period that is longer than the first heartbeat timeout period. The second message can also include data associated with the control system. For example, the first device 110 can send, during the second time period 220, the second message 222 to the second device 120 via the communications interface 111, and the second message 222 can include the second heartbeat timeout period. The first device 110 can generally use the second message 222 to stop the fast heartbeat (e.g., before inactive communication between the first device 110 and the second device 120). The first device 110 can generate the second message 222 such that the second message 222 includes a header that contains the first heartbeat timeout period. The second message 222 can also be any of a variety of suitable types of messages depending on the application. In some examples, to provide advantageous functionality for meeting various safety standards, the second timeout period can be greater than 5 milliseconds.

Upon receiving the second message 222 from the first device 110, the second device 120 can send second heartbeat messages to the first device 110 in accordance with the second heartbeat timeout period during the second time period 220. Since the second heartbeat timeout period is longer than the first heartbeat timeout period, the second device 120 can conserve computing resources since the second device 120 does not need to generate new heartbeat messages as often. Again, during the second time period 220, the second device 120 can send any suitable number of second heartbeat messages to the first device 110 depending on the length of the second time period 220 and the length of the second heartbeat timeout period. Additionally, during the second time period 220, the first device 110 can detect a communications fault using the second heartbeat messages receiving form the second device 120. In an example where the second heartbeat timeout period is 10 seconds, the first device 110 can detect that a second communications fault has occurred responsive to detecting that a period of 10.5 milliseconds has elapsed since the last of the second heartbeat messages was received from the second device 120 via the communications interface 111.

It should be noted that while the steps of the process 300 are shown in a particular order in FIG. 3, the process 300 may not include all steps shown, may include additional steps, or may include the steps in a different order.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for detecting a communications fault in a control system, the method comprising:
sending, by a first device in the control system during a first time period, a first message to a second device in the control system, the first message comprising data associated with the control system and a first heartbeat timeout period;
receiving, by the second device during the first time period, the first message from the first device;
sending, by the second device during the first time period, heartbeat messages to the first device in accordance with the first heartbeat timeout period;
receiving, by the first device during the first time period, the heartbeat messages from the second device in accordance with the first heartbeat timeout period;
detecting, by the first device during the first time period, the communications fault in the control system responsive to detecting that the heartbeat messages are no longer being received from the second device in accordance with the first heartbeat timeout period; and
sending, by the first device, a second message to the second device during a second period, the second message comprising a second heartbeat timeout period that is longer than the first heartbeat timeout period.

2. The method of claim 1, wherein:
the first device comprises a first safety programmable logic controller that executes a first safety function to control equipment in the control system; and
the second device comprises a second safety programmable logic controller that executes a second safety function to control the equipment in the control system.

3. The method of claim 1, wherein the first heartbeat timeout period is included in a header of the first message.

4. The method of claim 1, wherein sending, by the second device during the first time period, heartbeat messages to the first device comprises sending, by the second device during the first time period, heartbeat messages directly to the first device.

5. The method of claim 1, wherein sending, by the second device during the first time period, heartbeat messages to the first device comprises sending, by the second device during the first time period, heartbeat messages to the first device through an intermediary device.

6. The method of claim 1, further comprising receiving, by the first device, the first heartbeat timeout period based on a user input.

7. The method of claim 1, wherein:
the first heartbeat timeout period is between 0.5 milliseconds and 3 milliseconds; and
the second heartbeat timeout period is greater than 5 milliseconds.

8. The method of claim 1, further comprising:
sending, by the second device during the second time period, second heartbeat messages to the first device in accordance with the second heartbeat timeout period;
receiving, by the first device during the second time period, the second heartbeat messages from the second device in accordance with the second heartbeat timeout period; and
detecting, by the first device during the second time period, a second communications fault in the control system responsive to detecting that the second heartbeat messages are no longer being received from the second device in accordance with the second heartbeat timeout period.

9. One or more non-transitory computer-readable storage media having instructions stored thereon that, when executed by processing circuitry, cause the processing circuitry to:
send, from a first device in a control system during a first time period, a first message to a second device in the control system, the first message comprising data associated with the control system and a first heartbeat timeout period;
receive, at the second device during the first time period, the first message from the first device;
send, from the second device during the first time period, heartbeat messages to the first device in accordance with the first heartbeat timeout period;
receive, at the first device during the first time period, the heartbeat messages from the second device in accordance with the first heartbeat timeout period;
detect, at the first device during the first time period, a communications fault in the control system responsive to detecting that the heartbeat messages are no longer being received from the second device in accordance with the first heartbeat timeout period; and
send, from the first device, a second message to the second device during a second period, the second message comprising a second heartbeat timeout period that is longer than the first heartbeat timeout period.

10. The computer-readable media of claim 9, wherein the first heartbeat timeout period is included in a header of the first message.

11. The computer-readable media of claim 9, wherein the instructions, when executed by the processing circuitry, further cause the processing circuitry to receive, at the first device, the first heartbeat timeout period based on a user input.

12. The computer-readable media of claim 9, wherein:
the first heartbeat timeout period is between 0.5 milliseconds and 3 milliseconds; and
the second heartbeat timeout period is greater than 5 milliseconds.

13. The computer-readable media of claim 9, wherein the instructions, when executed by the processing circuitry, further cause the processing circuitry to:
send, from the second device during the second time period, second heartbeat messages to the first device in accordance with the second heartbeat timeout period;
receive, at the first device during the second time period, the second heartbeat messages from the second device in accordance with the second heartbeat timeout period; and
detect, at the first device during the second time period, a second communications fault in the control system responsive to detecting that the second heartbeat messages are no longer being received from the second device in accordance with the second heartbeat timeout period.

14. A device in a control system, the device comprising:
memory to store instructions; and
processing circuitry to execute the instructions to:
send, during a first time period, a first message to a second device in the control system, the first message comprising data associated with the control system and a first heartbeat timeout period;
receive, during the first time period, first heartbeat messages from the second device in accordance with the first heartbeat timeout period;
detect, by the first device during the first time period, a first communications fault responsive to detecting that the heartbeat messages are no longer being received from the second device in accordance with the first heartbeat timeout period;
send, during a second time period, a second message to the second device, the second message comprising a second heartbeat timeout period that is longer than the first heartbeat timeout period;
receive, during the second time period, the second heartbeat messages from the second device in accordance with the second heartbeat timeout period; and
detect, during the second time period, a second communications fault responsive to detecting that the second heartbeat messages are no longer being received from the second device in accordance with the second heartbeat timeout period.

15. The device of claim 14, wherein:
the device comprises a safety programmable logic controller;
the instructions comprise a safety function; and
the processing circuitry is to execute the safety function to control equipment in the control system.

16. The device of claim 15, wherein:
the second device comprises a second safety programmable logic controller; and
the second device comprises processing circuitry to execute a second safety function to control the equipment in the control system in cooperation with the device.

17. The device of claim 14, wherein the processing circuitry is to execute the instructions to generate the first message such that the first heartbeat timeout period is included in a header of the first message.

18. The device of claim 14, wherein the processing circuitry is to execute the instructions to receive the first heartbeat timeout period based on a user input.

19. The device of claim 14, wherein the processing circuitry is to execute the instructions to send the first message directly to the second device.

20. The device of claim 14, wherein:
the first heartbeat timeout period is between 0.5 milliseconds and 3 milliseconds; and
the second heartbeat timeout period is greater than 5 milliseconds.
